(19) United States
(12) Patent Application Publication
(10) Pub. No.: US 2005/0207407 A1
(43) Pub. Date: Sep. 22, 2005

(54) Method, apparatus and system for improved packet demultiplexing on a host virtual machine

(76) Inventor: Daniel P. Baumberger, Cornelius, OR (US)

Correspondence Address: INTEL CORPORATION, P.O. BOX 5326, SANTA CLARA, CA, 95056-5326, US

(21) Appl. No.: 10/802,198

(22) Filed: Mar. 16, 2004

(51) Int. Cl. H04L 12/56

(52) U.S. Cl. 370/389

(57) ABSTRACT

A method, apparatus and system enable improved demultiplexing in a virtual machine (“VM”) environment. Typically, guest physical addresses of the VMs are mapped to the physical page addresses of the host, thus requiring incoming packets to be copied from the host's direct memory access (“DMA”) buffer to the destination VM's buffer. Embodiments of the present invention unmap the guest physical address of the VMs from the physical page address of the host, thus freeing up a “pool” of pages to be mapped to the destination VM as necessary. Thus, by disassociating the guest physical address from the physical page address, embodiments of the invention eliminate the need for copying incoming packets from one buffer to another.

### BACKGROUND

Interest in virtualization technology is growing steadily as processor technology advances. One aspect of virtualization enables a single host running a virtual machine monitor (“VMM”) to present multiple abstractions and/or views of the host, such that the underlying hardware of the host appears as one or more independently operating virtual machines (“VMs”). Each VM may function as a self-contained platform, running its own operating system (“OS”), or a copy of the OS, and/or a software application(s) (the OS and software applications hereafter referred to collectively “guest software”). The VMM manages allocation of resources to the guest software and performs context switching as necessary to cycle between various virtual machines according to a round-robin or other predetermined scheme.

### BRIEF DESCRIPTION OF THE DRAWINGS

The present invention is illustrated by way of example and not limitation in the figures of the accompanying drawings in which like references indicate similar elements, and in which:

FIG. 1 illustrates an example of a typical virtual machine host;

FIG. 2 illustrates an embodiment of the present invention; and

FIG. 3 is a flowchart illustrating an embodiment of the present invention.

### DETAILED DESCRIPTION

Embodiments of the present invention provide a method, apparatus and system for monitoring system integrity in a trusted computing environment. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

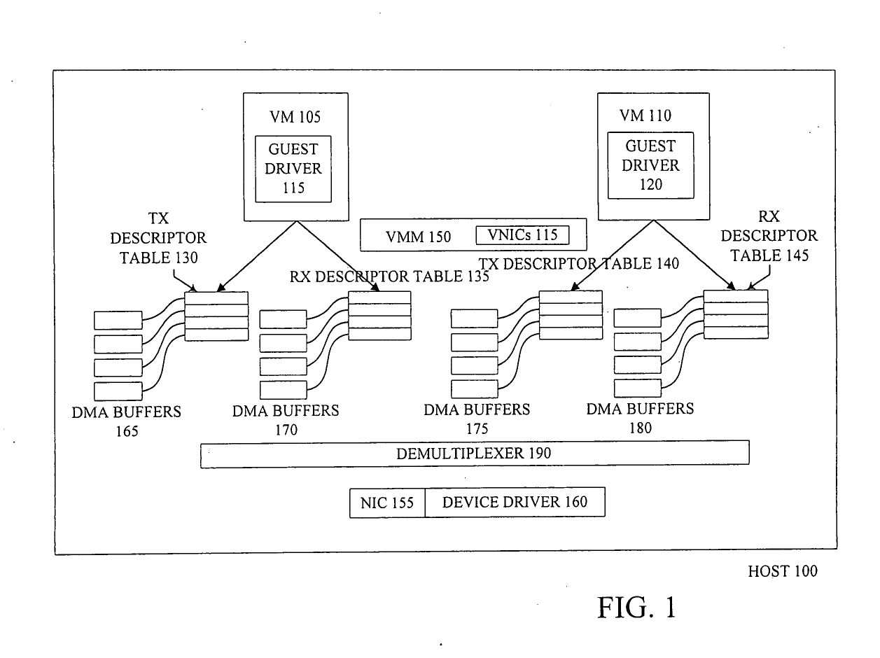

FIG. 1 illustrates an example of a typical virtual machine host device (“Host 100”). As previously described, a virtual-machine monitor (“VMM 150”) typically runs on the device and presents an abstraction(s) or view of the device platform (also referred to as “virtual machines” or “VMs”) to other software. Although only two VM partitions are illustrated (“VM 105” and “VM 110”, hereafter referred to collectively as “Virtual Machines”), these Virtual Machines are merely illustrative and additional virtual machines may be added to the host. VMM 150 may be implemented in software, hardware, firmware and/or any combination thereof (e.g., a VMM hosted by an operating system). VMM 150 has ultimate control over the events and hardware resources on Host 100 and allocates these resources to the Virtual Machines as necessary.

Host 100 may include a network interface card (“NIC 155”) and a corresponding device driver, Device Driver 160. In a non-virtualized environment, Device Driver 160 typically initializes NIC 155 with the addresses and sizes of all the DMA buffers available to Host 100. These addresses correspond to the physical addresses in Host 100's main memory. In a virtualized environment, on the other hand, each Virtual Machine is allocated a portion of the host's physical memory. Since the Virtual Machines are unaware that they are sharing the host's physical memory with each other, each Virtual Machine perceives its own memory region as non-virtualized. More specifically, each Virtual Machine assumes that its memory allocation starts at address 0 and continues up to the size of the block of memory allocated to it. In this situation, if more than one Virtual Machine is running (e.g., if both VM 105 and VM 110 are running), only one Virtual Machine may actually be loaded at physical address 0. The other Virtual Machines may have their virtual address 0 mapped to a different physical address.

The device drivers in a virtualized environment may initialize a virtual NIC (“VNIC”) relative to the virtual addresses as follows. VMM 150 may create and maintain virtual NICs for the various Virtual Machines on Host 100 (collectively “VNICs 115”). Each VNIC may have an associated software device driver (“Guest Driver 120” and “Guest Driver 125” respectively, collectively “Guest Drivers”) capable of initializing the VNICs. More specifically, the Guest Drivers may establish transmit DMA tables (illustrated as “TX Descriptor Table 130 and “TX Descriptor Table 140”), receive DMA tables (illustrated as “RX Descriptor Table 135” and “RX Descriptor Table 145”) and corresponding DMA buffers (illustrated as DMA Buffers 170 and 180 for the receive buffers and DMA Buffers 165 and 175 for the transmit buffers). These DMA buffers may be associated with “pages” and one or more page tables may be maintained for each DMA buffer. The concept of pages is well known to those of ordinary skill in the art and further description thereof is omitted herein in order not to unnecessarily obscure embodiments of the present invention. Since the Guest Drivers are only aware of their respective Virtual Machine's virtual addresses on Host 100, all entries in the DMA tables are maintained relative to the virtual addresses, i.e., the “guest physical addresses.” Thus, for example, if an entry in the DMA table indicates that a DMA buffer is loaded at “physical” address 0, it may in fact be loaded at physical address 257.

When a packet is received by NIC 155, the packet is typically written to an available DMA buffer unassigned to a specific Virtual Machine. Demultiplexer 190 may then examine the packet to determine its destination Virtual Machine (e.g., VM 105) and then copy the packet from its current DMA buffer to the buffer assigned to its destination Virtual Machine, i.e., the physical address for the destination Virtual Machine. This two-step process (i.e., copying into a host DMA buffer then transferring to the destination) may have significant performance implications for Host 100's receiving capacity.

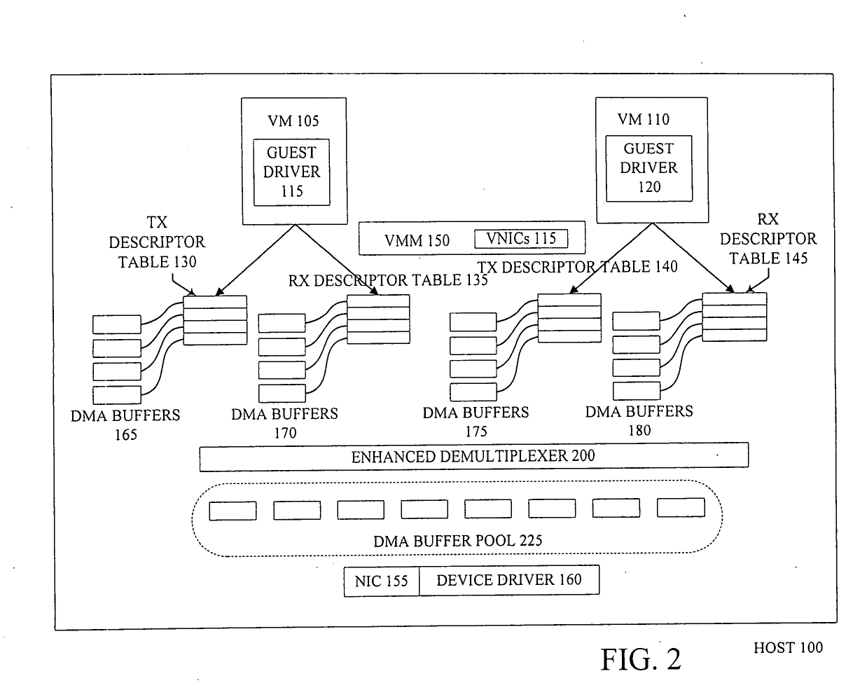

Embodiments of the present invention enable packets to be routed to Virtual Machines without the two-step copying process described above. FIG. 2 illustrates an embodiment of the present invention. As previously described, the Guest Drivers may initialize the VNICs by establishing DMA tables and buffers relative to the guest physical addresses. In one embodiment, each DMA buffer is associated with a single page. When the DMA tables and buffers are established, Enhanced Demultiplexer 200 may proceed to unmap the guest physical address from the host physical address in the page tables. The term “Enhanced Demultiplexer 200” shall include a demultiplexer enhanced to enable various embodiments of the present invention as described herein, a VNIC or other component capable of enabling these embodiments and/or a combination of a demultiplexer and such component(s). Enhanced Demultiplexer 200 may therefore be implemented in software (e.g., as a standalone program and/or a component of a host operating system), hardware, firmware and/or any combination thereof.

To unmap the guest physical address from the host physical address, Enhanced Demultiplexer 200 may access the page tables and invalidate the entries in the page tables for each available DMA buffer. Enhanced Demultiplexer 200 may also clear the contents of each of the physical pages. As a result of this dissociation between the guest physical addresses and host physical addresses, the Virtual Machines no longer have direct access to the memory region allocated to them. Instead, the Enhanced Demultiplexer 200 may thereafter have a “pool” of unmapped pages (illustrated as “DMA Buffer Pool 225”) available to be assigned.

Thus, in order to utilize the memory regions, in one embodiment, the unmapped pages may be submitted to Enhanced Demultiplexer 200 for use by any Virtual Machine. In other words, the pages are no longer associated with specific Virtual Machines and Enhanced Demultiplexer 200 may now allocate from DMA Buffer Pool 225 to Virtual Machines as appropriate. In one embodiment, Enhanced Demultiplexer 200 may submit DMA Buffer Pool 225 to NIC 155 for reception. When NIC 155 receives a packet, the packet may be written to a buffer in DMA Buffer Pool 225. In one embodiment of the present invention, however, since DMA Buffer Pool 225 is dissociated from the Virtual Machines, Enhanced Demultiplexer 200 may allocate any available buffer in the current buffer pool to the destination Virtual Machine, regardless of the Virtual Machine from which the buffer originated.

More specifically, Enhanced Demultiplexer 200 may examine the incoming packet to determine the packet's destination VNIC (e.g., by examining the Media Address Control (“MAC”) address and/or Internet Protocol (“IP”) address), and once the destination VNIC has been determined, Enhanced Demultiplexer 200 may hand the physical page address to the destination VNIC, i.e., assign the current buffer in DMA Buffer Pool 225 (containing the incoming packet) to the destination VNIC. The destination VNIC may then create a mapping from the next guest physical address in the receive DMA table (i.e., RX Descriptor Table 170 or RX Descriptor Table 175) to the host physical address of the page with the incoming packet (i.e., its current location in DMA Buffer Pool 225).

Thus, in one embodiment, by freeing DMA Buffers 180 from their association with specific Virtual Machines, these free buffers (DMA Buffer Pool 225) may be reallocated as necessary to avoid having to copy incoming packets to different DMA buffers on Host 100. After the destination VNIC has completed processing the packet in the assigned buffer, the VNIC may then inject appropriate interrupts into the destination Virtual Machine to signal the Guest Driver that the processing is complete. The Guest Driver may thereafter re-submit the receive buffer back to the Enhanced Demultiplexer 200, which may may unmap the guest physical address from the host physical address of the page on which it resides, and clear the page. The buffer thus once again becomes part of DMA Buffer Pool 225 and may be allocated as necessary to a destination Virtual Machine.

Embodiments of the present invention may be implemented in a variety of virtual environments. Thus, for example, an embodiments of the invention may be implemented on a trusted computing environment such as processors incorporating Intel Corporation's LaGrande Technology (“LT™”) (LaGrande Technology Architectural Overview, published in September 2003) and/or within other similar computing environments. Certain LT features are described herein in order to facilitate an understanding of embodiments of the present invention and various other features may not be described in order not to unnecessarily obscure embodiments of the present invention.

LT is designed to provide a hardware-based security foundation for personal computers (“PCs”), to protect sensitive information from software-based attacks. LT defines and supports virtualization, which allows LT-enabled processors to launch virtual machines. LT defines and supports two types of VMs, namely a “root VM” and “guest VMs”. The root VM runs in a protected partition and typically has full control of the PC when it is running and supports the creation of various VMs.

LT provides support for virtualization with the introduction of a number of elements. More specifically, LT includes a new processor operation called Virtual Machine Extension (VMX), which enables a new set of processor instructions on PCs. VMX supports virtualization events that require storing the state of the processor for a current VM and reloading this state when the virtualization event is complete. These virtualization events or control transfers are typically called “VM entries” and “VM exits”. Thus, a VM exit in a guest VM causes the PC's processor to transfer control to a root VM entry point. The root VM thus gains control of the processor on a VM exit and may take action appropriate in response to the event, operation, and/or situation that caused the VM exit. The root VM may then return to control of the PC's processor to the guest VM via a VM entry. An embodiment of the present invention may be implemented in hardware-enforced VM environments such as VMX. Thus, for example, virtualization events may be utilized to implement unmapping and/or reallocating of the DMA buffers as described herein.

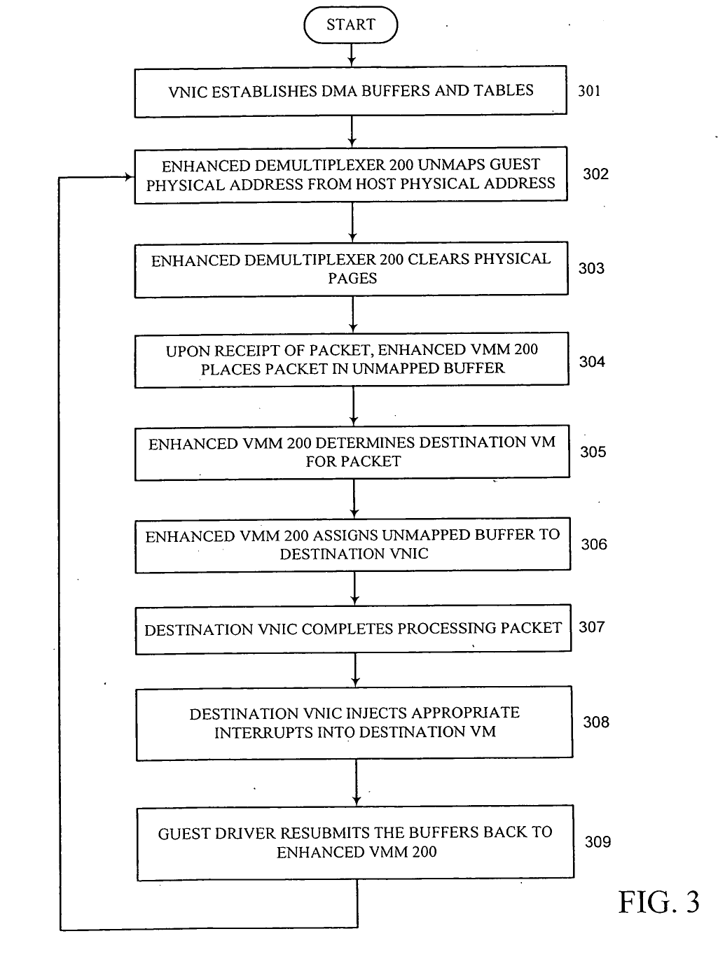

FIG. 3 is a flow chart illustrating an embodiment of the present invention. Although the following operations may be described as a sequential process, many of the operations may in fact be performed in parallel and/or concurrently. In addition, the order of the operations may be re-arranged without departing from the spirit of embodiments of the invention. In 301, DMA tables and buffers may be established by a VNIC on a host. In one embodiment, each DMA table entry is associated with a buffer residing on one or more pages, each of which has a mapping of the guest physical address to the host physical address stored in the page tables. In 302, Enhanced Demultiplexer 200 may unmap the guest physical addresses from the host physical addresses and in 303, the contents of the host physical pages may be cleared. Upon receipt of a packet, Enhanced Demultiplexer 200 may place the packet in an unmapped buffer in 304, and in 305, Enhanced Demultiplexer 200 may determine the destination Virtual Machine for the packet. In 306, Enhanced VMM 200 may assign the buffer in which the packet was placed to the VNIC for the destination Virtual Machine. In 307, the VNIC for the destination Virtual Machine may complete processing the packet in the assigned buffer and thereafter, in 308, the VNIC may inject appropriate interrupts into the destination Virtual Machine to signal the Guest Driver that the processing is complete. The Guest Driver may in 309 re-submit the receive buffer back to Enhanced Demultiplexer 200 and the process may be repeated.

In addition to trusted computing environments, embodiments of the present invention may be implemented on a variety of other computing devices. According to an embodiment of the present invention, these computing devices (trusted and/or non-trusted) may include various components capable of executing instructions to accomplish an embodiment of the present invention. For example, the computing devices may include and/or be coupled to at least one machine-accessible medium. As used in this specification, a “machine” and/or “trusted computing device” includes, but is not limited to, any computing device with one or more processors. As used in this specification, a “machine-accessible medium” and/or a “medium accessible by a trusted computing device” includes any mechanism that stores and/or transmits information in any form accessible by a computing device, including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the computing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method for demultiplexing an incoming packet to a virtual machine (“VM”), comprising:
unmapping a guest physical address from a host physical address in at least one page table entry associated with buffers in a direct memory access (“DMA”) table to create unmapped buffers;
placing the incoming packet into at least one of the unmapped buffers; and
allocating the at least one of the unmapped buffers to the VM to create a mapped buffer.

2. The method according to claim 1 wherein unmapping the guest physical address from the host physical address further comprises clearing the contents of a physical page associated with the host physical address.

3. The method according to claim 1 wherein allocating the at least one of the unmapped buffers further comprises temporarily assigning the at least one of the unmapped buffers to the VM to create the mapped buffer.

4. The method according to claim 1 further comprising:
causing the VM to release the mapped buffer; and
unmapping the guest physical address from the host physical address.

5. The method according to claim 4 wherein causing the VM to release the mapped buffer further comprises injecting a signal into the VM.

6. The method according to claim 5 wherein the signal is an interrupt.

7. A method for demultiplexing an incoming packet to multiple VMs, comprising:
decoupling a guest physical address for a virtual machine (“VM”) from a host physical address to create unmapped buffers;
placing incoming packets in the unmapped buffers;
examining the incoming packets to determine appropriate destination VMs; and
assigning the unmapped buffers to the appropriate destination VMs.

8. The method according to claim 7 wherein decoupling the guest physical address from the host physical address further comprises invalidating entries in at least one page table entry for buffers in a direct memory access table associated with the VM.

9. A system for demultiplexing an incoming packet to an appropriate virtual machine (“VM”), comprising;
a plurality of VMs;
a component coupled to the plurality of VMs, the component capable of invalidating entries in at least one page table entry for direct memory access (“DMA”) buffers to create unmapped buffers, placing the incoming packet in the unmapped buffers, determining which of the plurality of VMs is the appropriate destination virtual machine (“VM”) for the incoming packet and assigning the unmapped buffers with the incoming packet to the appropriate destination virtual machine.

10. The system according to claim 9 wherein the component is one of a demultiplexer and a virtual network interface card (“VNIC”).

11. The system according to claim 10 wherein the VNIC is maintained by a virtual machine manager (“VMM”) coupled to the plurality of VMs.

12. An article comprising a machine-accessible medium having stored thereon instructions that, when executed by a machine, cause the machine to demultiplex an incoming packet to a virtual machine (“VM”) by:
unmapping a guest physical address from a host physical address in at least one page table entry for buffers in a direct memory access (“DMA”) table to create unmapped buffers;
placing the incoming packet into at least one of the unmapped buffers; and
allocating the at least one of the unmapped buffers to the VM to create a mapped buffer.

13. The article according to claim 12 wherein the instructions, when executed by the machine, further cause the machine to unmap the guest physical address from the host physical address further by clearing the contents of a physical page associated with the host physical address.

14. The article according to claim 12 wherein the instructions, when executed by the machine, further cause the machine to allocate the at least one of the unmapped buffers by temporarily assigning the at least one of the unmapped buffers to the VM to create the mapped buffer.

15. The article according to claim 12 wherein the instructions, when executed by the machine, further cause the machine to demultiplex an incoming packet by:
causing the VM to release the mapped buffer; and
unmapping the guest physical address from the host physical address.

16. The article according to claim 15 wherein the instructions, when executed by the machine, further cause the VM to release the mapped buffer by injecting a signal into the VM.

17. The article according to claim 16 wherein the instructions, when executed by the machine, further cause the VM to release the mapped buffer by injecting a signal into the VM.

18. The article according to claim 17 wherein the instructions, when executed by the machine, further cause the VM to release the mapped buffer by injecting an interrupt into the VM.

19. An article comprising a machine-accessible medium having stored thereon instructions that, when executed by a machine, cause the machine to demultiplex an incoming packet to multiple VMs by:
decoupling a guest physical address for a virtual machine (“VM”) from a host physical address to create unmapped buffers;
placing incoming packets in the unmapped buffers;
examining the incoming packets to determine appropriate destination VMs; and
assigning the unmapped buffers to the appropriate destination VMs.

20. The article according to claim 19 wherein the instructions, when executed by the machine further decouple the guest physical address from the host physical address further by invalidating entries in a direct memory access table associated with the VM.
